(19) United States
(12) Patent Application Publication
(10) Pub. No.: US 2005/0270150 A1
(43) Pub. Date: Dec. 8, 2005

(54) Monitoring of inner regions of an aircraft

(75) Inventors: Andre Freiling, Klosterseelte (DE); Klaus Schmoetzer, Stuhr (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/132,680

(22) Filed: May 19, 2005

Related U.S. Application Data
(60) Provisional application No. 60/598,259, filed on Aug. 3, 2004.

(30) Foreign Application Priority Data
May 19, 2004 (DE) 10 2004 024 884.2

(51) Int. Cl. G08B 19/00

(52) U.S. Cl. 340/521; 348/143; 340/584; 340/628

(57) ABSTRACT

The present invention includes a monitoring system in an aircraft for monitoring inner regions, such as cargo chambers, comprising a user interface by means of which the crew on board in a simple manner may obtain detailed information concerning the present or past state of the inner region. In this respect, the access to these information may be controlled remotely so that a fast and precise analysis of the dangerous situation may be carried out.

### CROSS-REFERENCE TO RELATED APPLICATIONS

This application claims the benefit of the filing date of U.S. Provisional Patent Application No. 60/598,259 filed Aug. 3, 2004, the disclosure of which is hereby incorporated herein by reference.

### FIELD OF THE INVENTION

The present invention relates to the monitoring of inner regions of an aircraft.

### BACKGROUND OF THE INVENTION

The inside room of an aircraft often comprises several inner regions or inside rooms separated from one another, which may not be inspected easily by the flight personnel, particularly by the qualified cockpit personnel. In this respect, particularly the front or back cargo chambers are concerned, which cannot be entered during the flight.

It is important though, that these regions are reliably monitored also during the flight, so that possibly occurring dislocations of cargo or, for example, the developing of smoke or fire may be determined in time, which then leads to an initiation of corresponding counter measures, as for example a landing at the next airport which may be reached.

Known monitoring systems for inner chambers of an aircraft, for example, employ a smoke detector which detects occurring fires or smoke generation and transmits a respective notice to the cockpit personnel. Certain environmental conditions in the cargo chambers may lead to false alarms of the smoke detectors. In such a case, the cockpit personnel cannot differentiate, whether the alarm is real or false.

Further, the monitoring of cargo chambers by means of CCD cameras installed on board is known, which are connected to a monitor in the cockpit, so that the cargo chambers may be supervised visually.

### SUMMARY OF THE INVENTION

There may be need for an improved monitoring of aircraft inner regions.

According to an exemplary embodiment of the present invention, a monitoring system for an aircraft for monitoring at least one first inner region from out of a second inner region is provided, particularly for detecting or observing of fire or smoke, comprising a first sensor device for measuring first physical data, wherein the first sensor device is disposed in the first inner region, and a user interface disposed in the second inner region, wherein the user interface comprises an output unit for outputting first information to a user on the basis of the first physical data, and a control unit for controlling the output unit or the first sensor device.

In this manner, there may be provided a monitoring system for the inner chambers in an aircraft which may allow for the measuring of physical data, as for example optical data, humidity or temperature, in a first chamber, whereupon based on the first physical data information may be output to a user, as for example the pilot, by means of an output unit in a second chamber, which may, for example, be the cockpit. In this case, the pilot, by means of a control unit, may control the output unit and/or may influence the first sensor device, respectively.

Exemplary embodiments of the present invention thus relate to a monitoring system in an aircraft for monitoring at least a first inner region from out of a second inner region, a user interface for a monitoring system in an aircraft, and a method of monitoring a first inner region from out of a second inner region, as well as an aircraft having such a monitoring system.

For example, there may be provided a monitoring unit (for at least one first inner region or chamber) having a user interface, by means of which the operation or function of the first sensor device or the output unit may be controlled from the side of the user (from out of a second inner region or chamber). Therefore, a controlling of the output unit or the first sensor device (which may be disposed in a first region) and thereby an exertion of influence concerning the type of the output information from the side of the user (which is situated in a second region) may be made possible, whereby the probability may be increased that an erroneously activated smoke alarm is detected as such by the user (pilot).

According to a further exemplary embodiment of the present invention, the monitoring system further comprises a data transmission device, wherein the data transmission device transmits the first physical data measured by the first sensor device to the user interface. The control unit may further comprise an input unit, by means of which control commands may be input at the side of the user to the output unit or to the first sensor device, wherein the control unit may allow for a selection of second physical data from the first physical data by the user, to output second detailed information (based on the second physical data) by means of the output unit to the user.

This monitoring system may comprise an input unit, by means of which the pilot may enter control commands to the output unit or the first sensor device. Further, the control unit may allow for the selection of certain physical data, as for example the data measured during a certain time interval. Further, this exemplary monitoring system may allow for the output of second detailed information based on the selected second physical data by means of the output unit to the user.

According to a further exemplary embodiment of the present invention, the monitoring system may further comprise a recording unit for storing the first physical data measured by the first sensor device, whereby, for example, a repeated or retroactive/feedback-like access to the first physical data may be secured.

According to a further exemplary embodiment of the present invention, by means of control commands input from the user side by means of the input unit, a selection may be made between several monitored chambers or between several sensor devices, wherein after selection of the first inner region or the first sensor device, there may be chosen between a playback mode and a real time mode at the user side. In this context, when in the real time mode, information based on currently measured first physical data may be output to the user by means of the output unit, wherein, when in the playback mode, by means of the output unit, information based on first physical data measured at an earlier point in time and stored in the recording unit may be output to the user.

It may therefore be possible for the cockpit personnel, to select between a present monitoring of the first inner region and a playback of information concerning the state of the inner chamber based on physical data which had been measured at an earlier point in time.

According to a further exemplary embodiment of the present invention, an event occurring in the first inner region may be detected by the first sensor device or by a second sensor device on the basis of a measurement of third physical data, wherein, when in the playback mode, a time interval correlating to the detected event in the first inner region may be selected, and wherein the information output to the user in the playback mode may be based on the first physical data which had been measured in the time interval.

Thereby, a monitoring system may be provided which may be applied for detecting certain events, as for example smoke developing or the formation of a heat source, and wherein, when in the playback mode, the user may chose a time interval, within which the detected event has occurred, and wherein thereupon the information concerning the physical data measured in this time interval may be presented to the user.

According to a further exemplary embodiment of the present invention, a monitoring system may be provided, wherein the output unit, besides the first information based on the first physical data or the second detailed information based on the second physical data, may further output third information to the user. The third information may be information concerning a system status, information concerning the real time mode, information concerning the playback mode, information concerning the point in time of a extinguishing event in the first inner region or information concerning the selected sensor, particularly with respect to a position of the selected sensor and an operability or availability or functionality of the selected sensor.

Thereby, a monitoring system may be provided which provides the user, besides detailed selected information based on the measured physical data, further with third (additional) information concerning, for example, the system status, the playback mode or the selected sensor. Therefore, the user may be provided with a plurality of important information items which may help her or him to correctly make respective decisions.

According to a further exemplary embodiment of the present invention, there may be provided a user interface for a monitoring system in an aircraft for monitoring at least one first region from out of a second inner region which may particularly be adapted for detecting or observing of fire or smoke, and may comprise an output unit for outputting information to a user on the basis of first physical data and a control unit for controlling the output unit or a first sensor device for measuring the first physical data.

Thereby, a user interface may be provided which may allow for controlling the output unit or the first sensor device (which may be disposed in a first region) and therefore, from the user side (which is situated in a second region), may allow for an exertion of influence to the kind of the output information, whereby the probability may be increased that the user (pilot) will detect an erroneously activated alarm as erroneous.

According to a further exemplary embodiment of the present invention, a method for monitoring at least one first inner region from out of a second inner region, particularly for detecting or observing fire or smoke, may be provided, wherein the first inner region and the second inner region may be positioned in an aircraft, and wherein the method may comprise the following steps: outputting first information to a user on the basis of first physical data by means of an output unit, and controlling the output unit or a first sensor device for measuring the first physical data by means of a control unit, wherein the first sensor device is disposed in the first inner region, and wherein the output unit and the control unit are disposed in the second inner region.

Thereby, a met hod may be provided which may allow for the measurement of the state of a first inner region and the analysis of this state by a user positioned in a second inner region, wherein the user may specifically influence the output of information and the acquiring of information, so that the user will, for example, also detect an erroneously activated alarm as erroneous.

According to a further exemplary embodiment of the present invention, there may be provided a computer program product for carrying out the above described method by means of a processor, when the computer program product is carried out by the processor.

### BRIEF DESCRIPTION OF THE DRAWINGS

Referring to the following figures, exemplary embodiments of the present invention are described.

FIG. 1 shows a schematic representation of an exemplary embodiment of a monitoring system according to the present invention.

FIG. 2 shows a first exemplary embodiment of a control unit according to the present invention.

FIG. 3 shows a second exemplary embodiment of a control unit according to the present invention.

FIG. 4 shows a third exemplary embodiment of a control unit according to the present invention.

FIG. 5 shows a first exemplary embodiment for the displaying of information output by means of the output unit.

FIG. 6 shows a second exemplary embodiment for the displaying of information output by means of the output unit.

FIG. 7 shows a third exemplary embodiment for the displaying of information output by means of the output unit.

FIG. 8 shows a fourth exemplary embodiment for the displaying of information output by means of the output unit.

FIG. 9 shows a fifth exemplary embodiment for the displaying of information output by means of the output unit.

FIG. 10 shows a sixth exemplary embodiment for the displaying of information output by means of the output unit.

FIG. 11 shows a seventh exemplary embodiment for the displaying of information output by means of the output unit.

FIG. 12 shows a flow chart of a method according to an exemplary embodiment of the present invention.

### DETAILED DESCRIPTION

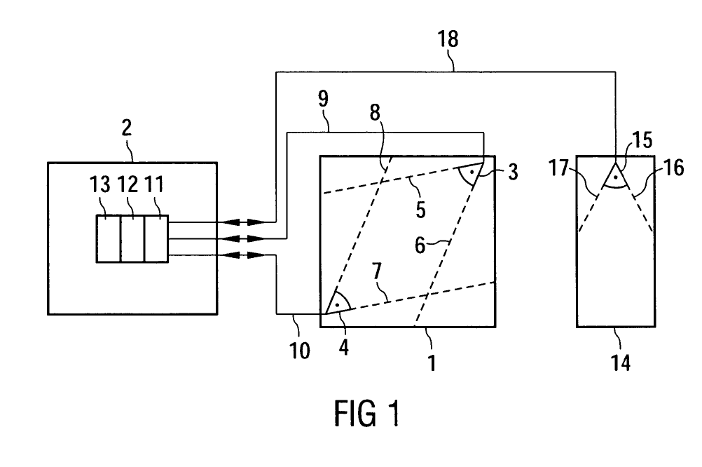

In the following description of the FIGS. 1 to 12, the same reference numerals are used for the same or corresponding elements.

FIG. 1 shows a schematic representation of an exemplary embodiment of a monitoring system according to the present invention. The monitoring system of FIG. 1 comprises a first sensor device 3 and a second sensor device 4 disposed in a first inner region 1. Further, the monitoring system comprises a third sensor device 15 disposed in a third inner region 14 and supervising a region indicated by dotted lines 16, 17. For example, the first inner region 1 is the front cargo chamber of an aircraft, the third inner region is the back cargo chamber of the aircraft. The positions of the sensor devices are shown as examples. Sensor devices for measuring additional physical parameters may be disposed at any desired position of the region.

The first sensor unit 3 comprises an optical sensor supervising the spatial region within the cone defined by the dotted lines 5 and 6. The second sensor device 4 comprises a second optical sensor covering the spatial region enclosed by the dotted lines 7 and 8. The sensor devices advantageously include sensors for measuring second, third or further physical parameters like temperature, humidity, pressure, etc. The physical data measured by the sensor devices 3, 4, 15 are transmitted by means of a data transmission device, which in the present example is realized as data lines 9, 10, 18, to a user interface. The user interface 11, 12, 13 is disposed in the second inner region 2, for example the cockpit region of an aircraft, and comprises an output unit 12, a control unit 11 and a recording unit 13. The output unit 12 is provided in such a manner that, by means of the output unit 12, information concerning the physical data measured by the sensor devices 3, 4 may be given to the user, for example in form of graphical representations of the first inner region 1 to be monitored or also in form of acoustic information, as for example an alarm signal in case of a breakout of fire.

It has to be taken into consideration that the data transmission device, which in case of the present example is embodied in form of data lines 9 and 10, may as well be embodied in form of a wireless data transmission device, for example by means of radio communication.

Further, it has to be taken into consideration that the physical data measured by the sensor units 3, 4, 15 may be processed, for example by a processor or a computer system evaluating or processing the measured physical data or a detected event. A processor of this kind or a computer system of this kind may for example be directly integrated into one of the sensor units 3, 4, 15 or may otherwise be integrated into the user interface or into the recording unit 13.

Image processing algorithms or analysis methods of this kind are well known to the skilled person.

The control unit 11 comprises an input unit, by means of which, by the user, control commands may be input to the output unit or the sensor devices 3, 4, 15. By means of the control unit, the pilot has the opportunity to perform a selection in a simple way concerning which measurement data at which time and in which form shall be represented in detail. This is particularly possible, because the measured data stream is continuously stored by the system within the recording unit 13, so that a later access to the measured data is possible from the side of an user.

Therefore, in case of a smoke notice in the back cargo chamber 1, the pilot may, by means of a simple button-pushing operation, for example, inspect the last ten minutes prior to the occurrence of the smoke notice event from the viewing angle of the optical sensor integrated into the sensor unit 3, in form of a time lapse film sequence of ten seconds duration. In this respect, the sensor unit 3 may, for example, also comprise optical filters, so that particularly heat radiation is emphasised. Further, the sensor unit 3 may comprise a temperature sensor or a pressure sensor, so that for example temperature increases in the back cargo chamber or pressure decreases are detectable. In combination with optical filters, therefore particularly fire sources or so called, “hot spots” may be detected as well.

In total, the simple access to the different sensors built into the sensor devices 3, 4, 15 in connection with the opportunity of returning to prior points in time within the context of a “rewind function” allows the pilot a qualified and substantiated evaluation of the actual situation in the rear cargo chamber. Therefore, possibly unnecessary landings or changes of course may be prevented.

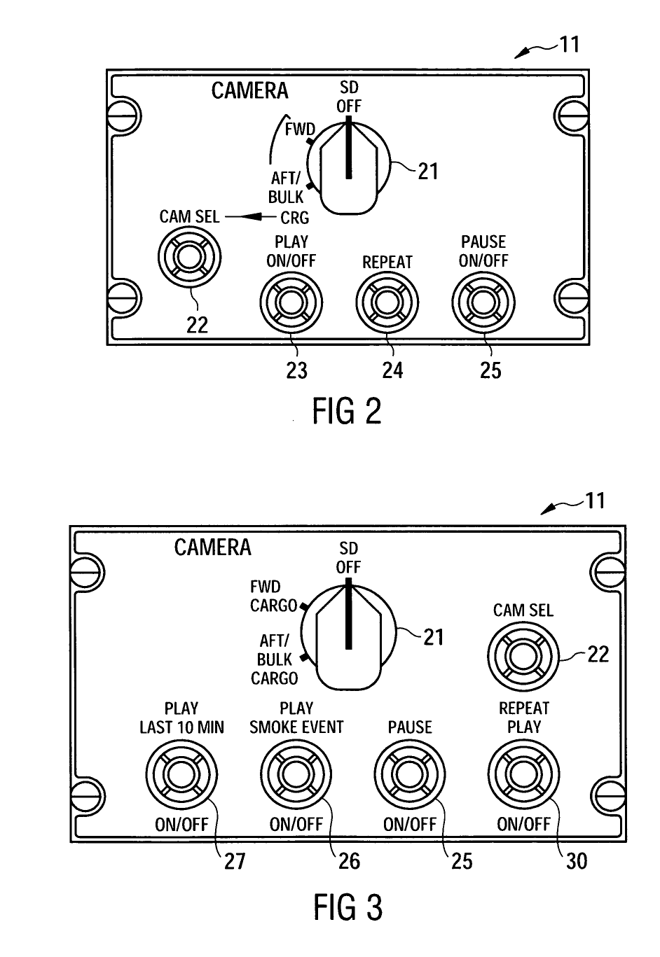

FIG. 2 shows a first exemplary embodiment of a control unit 11 for a user interface according to the present invention. The control unit 11 comprises several input units, which are selection switches 21 and selection knobs 22, 23, 24 and 25. If selection switch 21 is in the position SD OFF, there are no information shown in the output unit 12 further described in the following FIGS. 5 to 11. If a user, by means of selection switch 21, now chooses the function FWD, the system is in a manual mode for the front cargo chamber (see reference numeral 1 in FIG. 1). On the other hand, if the user, by means of the selection switch 21 selects the function AFT/BULK, the system is in a manual mode for another inner chamber, for example the backwards cargo chamber (reference sign 14 in FIG. 1). After selection, by selection switch 21, of the respective inner chamber to be monitored, the user may make a selection of the respective camera by means of selection button 22. Referring to FIG. 1, she or he thereby has the possibility to chose between sensor unit 3 and sensor unit 4 for the front cargo chamber 1 which each comprise a respective camera. In this respect, the selection is effected, for example, by repeated pressing of the button 22.

By pressing the button 23, the user may switch between a playback mode and, for example, a real time mode. When in the real time mode, in this context, information is displayed, which is based on physical data detected immediately before by one of the sensors. On the other hand, the playback mode concerns information about physical data detected at an earlier point in time and which is stored in the system. If, by means of button 23, the playback mode has been chosen, by pressing the repeat button 24 a certain playback sequence may be repeatedly played-back. A manual rewinding is not necessary in this context. Therefore, by simple pressing of the repeat button 24, a repeated and therefore precise analysis of the respective measured physical data may be obtained.

It is further possible to stop or pause a certain playback sequence by pressing the pause button 25, in order to analyse more precisely the respective information at this point in time.

FIG. 3 shows a second exemplary embodiment of a control unit for a user interface according to the present invention. As already described referring to FIG. 2, control unit 11 comprises a selection switch 21 for selecting various inner chambers and a selection knob 22 for selecting a respective camera or a respective sensor device.

After a certain event has been detected by one of the sensor units, for example a development of smoke or a beginning fire, the pilot is informed about it and may now select the respective inner chamber, in which this event has occurred, by means of the selection switch 21. She or he then has the possibility to chose a respective sensor by means of the selection knob 22. Further, the pilot has the possibility, by means of button 27, to playback information concerning the physical data measured within the last ten minutes. Further, by operating the button 26, she or he may as well explicitly playback the time interval in which the event, which means for example the smoke development, has occurred. This may for example be an appropriately set time interval of ten minutes duration, so that the begin of the event advantageously lies in the middle of this time interval. By pressing the button 25, a played sequence may be stopped or paused. By pressing the button 30, the pilot may repeatedly play the last played sequence.

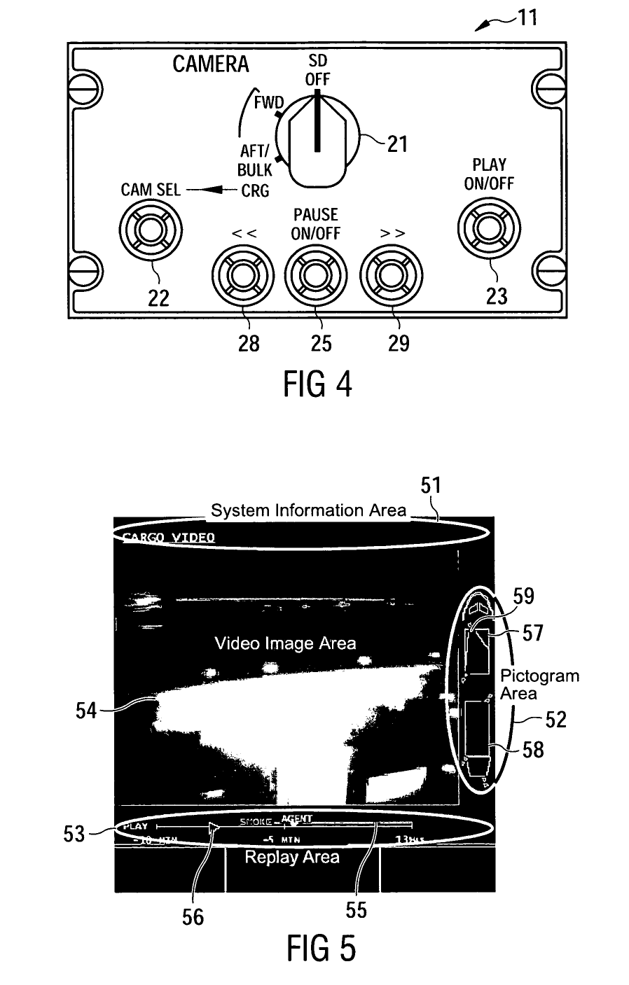

FIG. 4 shows a third exemplary embodiment of the control unit 11 for a user interface according to the present invention. The control unit 11 of FIG. 4 comprises additional spooling functionality by means of buttons 28 and 29. By operating the play button 23, information concerning the physical data of the respective chosen sensor measured during the last ten minutes is played back. This playing back occurs, for example, in form of a time lapse mode, so that the ten minutes may be played back within few seconds, for example within eight seconds. By pressing the buttons 28 or 29, the time lapse playback time may be slowed down or further accelerated, respectively.

It is further possible to implement, for example, by means of the button 30 of the FIG. 3, a function by which an automatically repeated playback of a certain sequence is secured. This playback can be stopped at any time by pressing the pause button 25.

Further, in an exemplary embodiment, it is provided that by pressing the playback button 23, a playback of the last ten minutes occurs, for example in a time lapse mode of eight seconds duration, whereupon a switching into the real time mode is automatically effected. By means of repeated pressing of the button 23, a playback of the last ten minutes occurs again, which may be stopped by pressing the pause button 25 at any time.

It is to be noted that the functionality of the exemplary embodiments shown in FIG. 2 to 4 may be combined with each other, so that individually configurable control units 11 may be realised.

FIG. 5 shows a first exemplary embodiment for the representation of information output by means of the output unit 12. In this context, the output of the information is effected by means of a monitor whose image comprises several regions. In this case are concerned: a region for information concerning a system status 51, a region concerning the selected sensor or the selected sensor unit, the so called pictogram region 52, a region 53 in which information concerning the playback mode are presented and a region 54, in which images measured by one of the sensors are played back.

In the region for displaying the system status 51, various texts may be inlayed concerning the names and the status of the system. If the system is in the operational state, there is, for example, the text CARGO VIDEO inlayed here. If the system verifies a fire event or a smoke development in one of the inner chambers, the text SMOKE CONFIRMED or similar is shown at the display screen in the region 51 in addition to the status display. If the smoke event or fire event is not verified, there is, for example inlayed a respective text SMOKE NOT CONFIRMED. If a verification of an event is not possible, for example, the text CONFIRMATION NOT AVAIL is inlayed. This case may for example occur, if a malfunction within the system occurs or if due to bad visibility situations a substantiated analysis of the events may not be effected at the side of the system.

There may of course be displayed other messages concerning the system status as well.

In region 53 are, for example, displayed information concerning the playback mode. In this case, for example the representation of a playback bar 55 is concerned, if the system is in the playback mode. In this case, the selection of the playback mode by means of the word PLAY or the like is displayed to the pilot. Each time if, for example, by pressing the selection switch 23 (see FIG. 2) the playback mode is chosen, respective information is displayed in region 53 shown in FIG. 5.

By means of a cursor 56, the point in time is symbolised, at which the information visualised in region 54 have been measured. The triangular symbol 56 represented in FIG. 5 further symbolises that the system is presently in a continuously playing playback operation. Further functions, as for example “pause”, “forward spooling” or “backwards spooling”, may be visualised by respective symbols. According to an exemplary embodiment of the present invention, the time interval represented in the region 53 is frozen, as long as the playback function is activated.

In case of a dispensing of extinguishing means in one of the monitored chambers, according to an exemplary embodiment of the present invention, the point in time of the dispensing of extinguishing means may be symbolised on the playing bar 55, symbolising the played time interval, by means of a respective labelling, for example by means of a vertical line bearing the caption AGENT.

The pictogram region 52 symbolises the two cargo chambers to be monitored, represented by

its outlines 57, 58. Further, the sensor positions within the two cargo chambers are displayed. In the present example, sensor 59 is selected. According to an exemplary embodiment of the present invention, the selected camera is represented in the color green. If the camera detects smoke or the like, the camera is represented in the color red. The field of view of the selected camera is outlined by means of lines. Each camera which is not selected is represented in grey color. The selected cargo chamber is represented in the color green. Cargo chambers which are not selected are represented in grey. All cameras which have verified smoke are represented in red. All defective cameras are represented in yellow.

In this respect, it shall be noted that the represented example only is an exemplary embodiment. Of course, the different cameras and chambers to be monitored, and/or the different system states, respectively, may be symbolised in other than the above represented colours.

Region 54 represents the playback region for recorded and, if desired, electronically processed measured physical data, as for example optical images. According to an exemplary embodiment of the present invention, the real time state of the respective cargo chamber is displayed here, if, by means of the button 23 of FIG. 2, the real time mode has been selected. If, by means of button 23, the playback mode is selected, there is played back here for example a film sequence concerning the last ten minutes from the view of the selected camera.

In case of an error in the system or in case of an unusual system state, according to an exemplary embodiment of the present invention, the video image of a respective message is superposed. This may for example be the text message NOT AVAIL, if, for example, the selected camera is not operable. Moreover, according to a further embodiment of the present invention, in case an open cargo chamber door, the text CRG DOOR OPEN or the like is overlaid over the fed-in image. If the system is in a system test mode or an initialising mode or the like, according to an exemplary embodiment of the present invention, the message SYSTEM TEST or the like is inlayed.

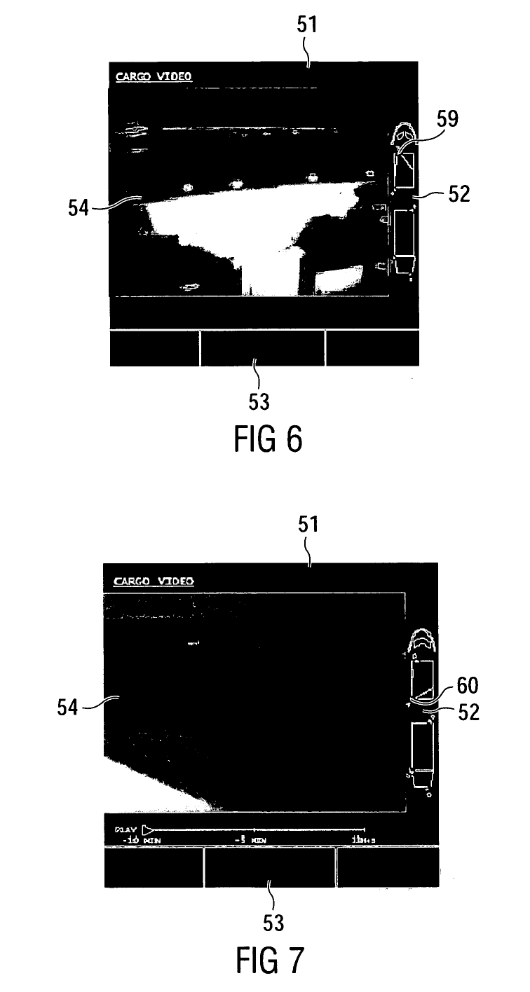

FIG. 6 to 11 show further exemplary embodiments for the displaying of information output by means of the output unit.

FIG. 6 shows the displaying of information, when the front camera 59 is selected in real time mode.

FIG. 7 shows the displaying of information output by means of the output unit 12, when camera 60 is selected in playback mode.

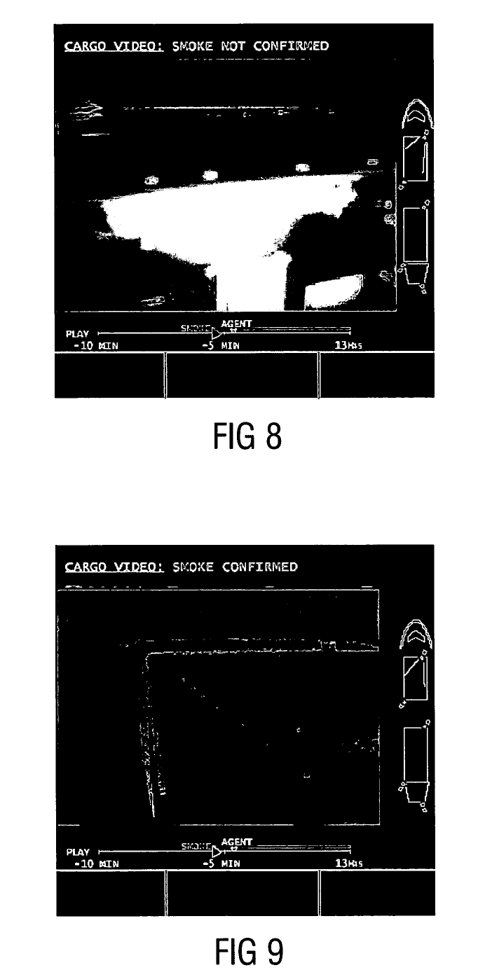

FIG. 8 shows an exemplary embodiment for the displaying of information output by means of the output unit in case of a smoke alarm which is not verified though.

FIG. 9 shows the case of a smoke alarm which is verified by the system. In this case, according to an exemplary embodiment of the present invention, the smoke development or the fire source may be accordingly emphasised, for example in form of a colouring in the playback region 54. The corresponding image processing or analysis algorithms are well known to the skilled person.

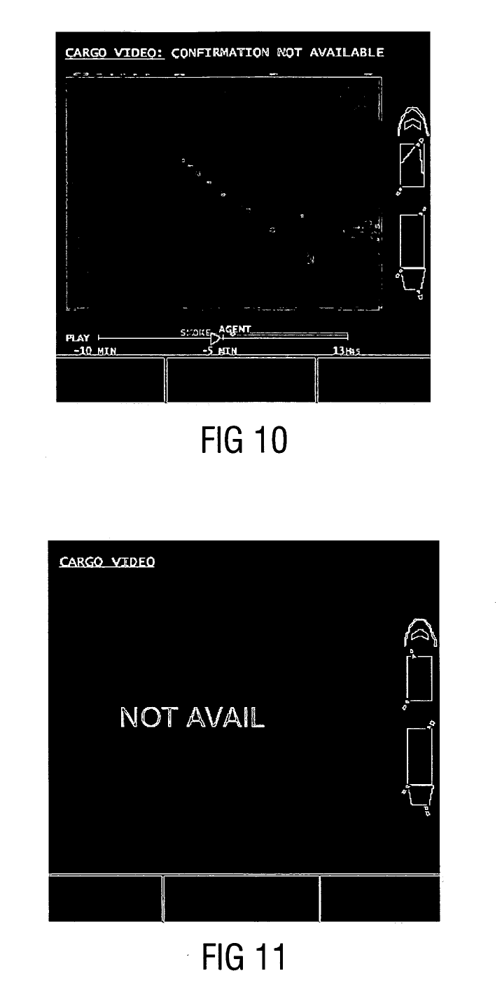

FIG. 10 shows a further exemplary embodiment for the representation of information output by means of the input unit. In this case, for example due to a malfunction inside the system or an external malfunction, a confirmation or verification of a fire event is not possible.

The case of a complete camera failure is shown in FIG. 11. In this case, for example the writing NOT AVAIL is overlaid in the image region 54.

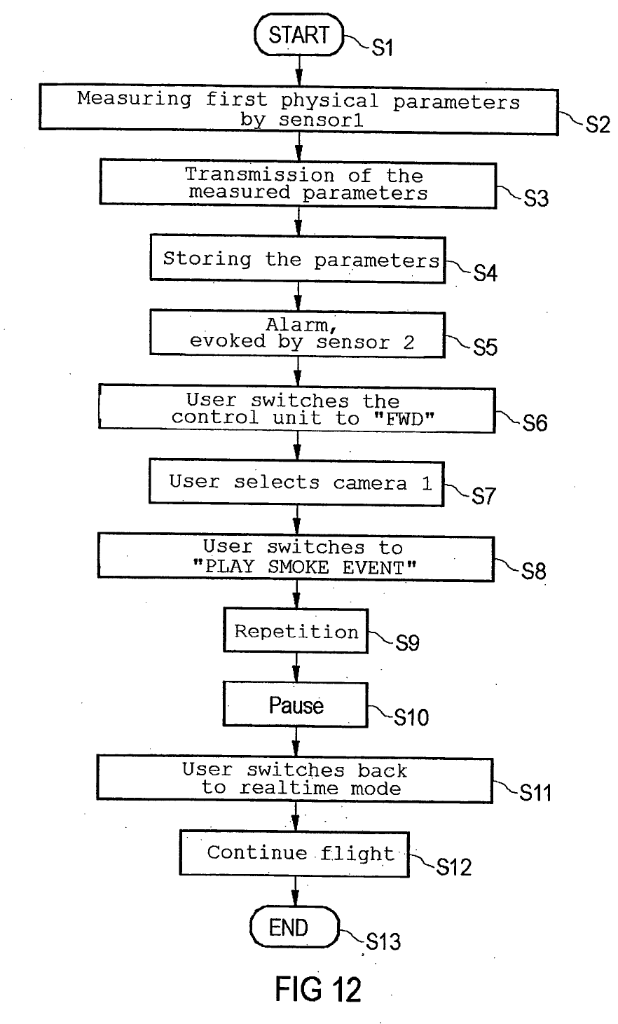

FIG. 12 shows a flow chart of an exemplary method according to the present invention. The method starts in step S1, for example with the initialising of the system. In step S2, a measuring of first physical parameters or data by sensor unit 1 is effected which is, for example, disposed in the front cargo chamber. In a third step, the transfer of the measurement data to the user interface in the cockpit of the aircraft is effected. In a fourth step, the transferred data is stored within a recording unit here.

After a further sensor in the front cargo chamber has detected a special event, for example a developing of smoke, a corresponding alarm is given (step S5). As a reaction to this alarm, the pilot in step S6 switches the control unit to FWD to chose the front cargo chamber. In step S7, the pilot now selects camera 1 integrated into the first sensor unit. The pilot now pushes the button 26 “PLAY SMOKE EVENT” shown in FIG. 3. The system is now in the playback mode, and information concerning the first physical data recorded during the ten minute time interval during which the alarm has been given, is displayed by means of the output unit. Subsequent to playback of this ten minutes time interval (for example in a fifteen second time lapse mode), the pilot pushes the button 30 of FIG. 3 for triggering a repeated playback of this information. This is done in step S9. During this playback operation, the pilot pushes the button 25 to create a still image at a certain point in time, by means of which she or he can more precisely analyse a certain event (step S10). In the present example, the pilot thereby realises that the smoke alarm has been effected by the system in error. In step S11, she or he switches to real time mode, to analyse, as a matter of form, once again the actual state of the system. In step S12, the pilot then continues the flight, as the alarm has obviously been a false alarm.

By means of this optimised man-machine-interface, it is therefore possible for the cockpit-crew, to precisely analyse a respective dangerous situation on the basis of recorded and selectable information provided by the various sensors in the cargo chambers, and to make corresponding decisions. Therefore, the degree of danger of the occurred situation may be evaluated.

The embodying of the invention is not restricted to the exemplary embodiments shown in the figures. Rather, a plurality of variants may be thought of which make use of the shown solution and the inventive principle also in case of substantially differently natured embodiments.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A monitoring system in an aircraft for monitoring at least one first inner region from a second inner region, particularly for detecting or observing fire or smoke, wherein the monitoring system comprises:
a first sensor device; and
a user interface;
wherein the first sensor device is adapted for measuring first physical data and is disposed in the first inner region;
wherein the user interface is disposed in the second inner region; and
wherein the user interface has an output unit for outputting first information to a user on the basis of the first physical data and a control unit for controlling at least one of the output unit and the first sensor device.

2. The monitoring system according to claim 1, further comprising:
a data transmission device;
wherein the data transmission device is adapted to transmit the first physical data measured by the first sensor device to the user interface;
wherein the control unit comprises an input unit for inputting, from a user side, control commands to the output unit or the first sensor device;
wherein the control unit allows for a selection of second physical data from the first physical data by the user; and
wherein, on the basis of the second physical data, second detailed information may be output to the user by means of the output unit.

3. The monitoring system according to claim 1, further comprising:
a recording unit for storing the first physical data measured by the first sensor device.

4. The monitoring system according to claim 3,
wherein, by means of the control commands which may be input from the user side by means of the input unit, a selection between several monitored chambers or between several sensor devices may be carried out;
wherein, subsequent to selecting the first inner region or the first sensor device, there may be selected between a playback mode and a real time mode by the user;
wherein, when in the playback mode, information based on first physical data measured at an earlier point in time and stored in the recording unit is output to the user by means of the output unit; and
wherein, when in the real time mode, information based on currently measured first physical data is output to the user by means of the output unit.

5. The monitoring system according to claim 4, further comprising a second sensor device disposed in said first inner region;
wherein an event occurring in the first inner region may be detected by the first sensor device or the second sensor device on the basis of a measurement of third physical data;
wherein, when in the playback mode, a time interval may be selected which correlates to the detected event in the first inner region; and
wherein the information output to the user, when in the playback mode, is based on the first physical data measured in the time interval.

6. The monitoring system according to claim 1,
wherein the first sensor device comprises an optical sensor; and
wherein the first physical data are images of the first inner region.

7. The monitoring system according to claim 1,
wherein the output unit is further adapted for outputting to the user, besides the first information based on the first physical data or the second detailed information based on the second physical data, third information selected from the group consisting of information concerning a system status, information concerning the real time mode, information concerning the playback mode, information concerning the point in time of an extinguishing event in the first inner region, and information concerning the selected sensor, particularly with respect to a position of the selected sensor and an operability or availability of the selected sensor.

8. A user interface for a monitoring system in an aircraft, the monitoring system being adapted for monitoring at least one first inner region from out of a second inner region, particularly for detecting or observing fire or smoke, wherein the user interface comprises:
an output unit; and
a control unit;
wherein the output unit is adapted for outputting information to a user on the basis of first physical data; and
wherein the control unit is adapted for controlling the output unit or a first sensor device for measuring the first physical data.

9. The user interface according to claim 8, further comprising:
a recording unit for storing the first physical data measured by the first sensor device;
wherein the control unit has a first input unit for inputting control commands to the output unit or the first sensor device by the user;
wherein the control unit allows for a selection of second physical data from the first physical data by the user; and
wherein second detailed information based on the second physical data may be output to the user by means of the output unit.

10. The user interface according to claim 9,
wherein the control commands which may be input from the user side by means of the input unit, a selection between several monitored chambers or among several sensor devices may be carried out;
wherein, subsequent to selecting the first inner region or the first sensor device, the user may chose between a playback mode and a real time mode;
wherein, when in the playback mode, the output unit may output to the user information based on first physical data measured at an earlier point in time and stored in the recording unit; and
wherein, when in the real time mode, the output unit outputs information based on currently measured first physical data to the user.

11. The user interface according to claim 10, further comprising a second sensor device;
wherein an event occurring in the first inner region may be detected by the first sensor device or the second sensor device on the basis of a measurement of third physical data;
wherein, when in the playback mode, a time interval may be selected which correlates to the detected event in the first inner region; and
wherein the information output to the user, when in the playback mode, is based on the first physical data measured in the time interval.

12. The user interface according to claim 8,
wherein the output unit is further adapted for outputting to the user, besides the first information based on the first physical data or the second detailed information based on the second physical data, third information selected from the group consisting of information concerning a system status, information concerning the real time mode, information concerning the playback mode, information concerning the point in time of an extinguishing event in the first inner region, information concerning the selected sensor, particularly with respect to position of the selected sensor and an operability or availability of the selected sensor.

13. A method for monitoring at least one first inner region of an aircraft from out of a second inner region of an aircraft, particularly for detecting or observing fire or smoke, wherein the first inner region and the second inner region are situated inside an aircraft, wherein the method comprises the following steps:
outputting first information to a user on the basis of first physical data by means of an output unit; and
controlling the output unit or a first sensor device for measuring the first physical data by means of a control unit, wherein the first sensor device is disposed in the first inner region, and wherein the output unit and the control unit are disposed in the second inner region.

14. The method according to claim 13, further comprising the step of
storing of the first physical data measured by the first sensor device in a recording unit;
wherein the control unit comprises a first input unit by means of which, by the user, control commands may be input to the output unit or to the first sensor device; and
wherein the control unit allows for a selection, by the user, of second physical data from the first physical data; and
wherein second detailed information based on the second physical data may be output to the user by means of the output unit.

15. The method according to claim 14, further comprising the steps of:
effecting a selection between several monitored chambers or between several sensor devices by means of the control commands which may be input by the user by means of the input unit;
selecting, after selection of the first inner region or the first sensor device, between a playback mode and a real time mode from the user side;
when in the playback mode, outputting information based on first physical data measured at an earlier point in time and stored in the recording unit to the user by means of the output unit; and
when in the real time mode, outputting information based on currently measured first physical data to the user by means of the output unit.

16. Computer program product for carrying out the method according to claim 13 by means of a processor, when the computer program product is carried out by the processor.

17. Aircraft, comprising a monitoring system according to claim 1.
